(19) United States
(12) Patent Application Publication
(10) Pub. No.: US 2022/0044175 A1
(43) Pub. Date: Feb. 10, 2022

(54) Method for Designing a Traffic Infrastructure, Electronic Computing Device for Carrying Out a Method, Computer Program, and Data Carrier

(71) Applicant: Siemens Aktiengesellschaft, München (DE)

(72) Inventors: Matthias Huber, Assling (DE); Martin Küppers, München (DE); Nils Namockel, Aachen (DE)

(73) Assignee: Siemens Aktiengesellschaft, München (DE)

(21) Appl. No.: 17/415,511

(22) PCT Filed: Dec. 12, 2019
(86) PCT No.: PCT/EP2019/084845

§ 371 Date: Jun. 17, 2021

(30) Foreign Application Priority Data
Dec. 21, 2018 (DE) 10 2018 222 820.5

(51) Int. Cl. G06Q 10/06

(52) U.S. Cl. CPC G06Q 10/06313; G06K 9/00651

(57) ABSTRACT

Various embodiments of the teachings herein include a method for designing a traffic infrastructure on the basis of height data provided by a height monitoring object comprising: a) evaluating the height data detected by a sensor unit of the height monitoring object and generating an evaluation dataset; b) identifying a component of the traffic infrastructure from the evaluation dataset; c) identifying a user of the traffic infrastructure from the evaluation dataset; and d) determining a utilization of the component by the user.

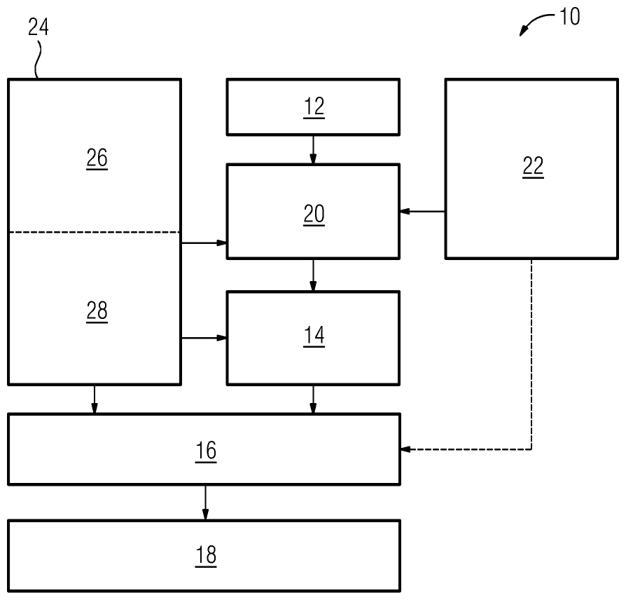

### CROSS-REFERENCE TO RELATED APPLICATIONS

This application is a U.S. National Stage Application of International Application No. PCT/EP2019/084845 filed Dec. 12, 2019, which designates the United States of America, and claims priority to DE Application No. 10 2018 222 820.5 filed Dec. 21, 2018, the contents of which are hereby incorporated by reference in their entirety.

### TECHNICAL FIELD

The present disclosure relates to traffic infrastructure. Various embodiments include electronic computing devices and/or methods for designing a traffic infrastructure.

### BACKGROUND

With the progressive electrification of traffic, an adaptation of the traffic infrastructure is necessary. Thus, for example, an infrastructure for supplying the drives of vehicles with energy must be re-examined given that vehicles are increasingly being fueled with electricity rather than gasoline or diesel. A charging infrastructure with charging infrastructure components, such as, for example, charging poles, for electrical energy or current is therefore increasingly required.

In order to operate the charging poles efficiently so that the operation is, in particular, ecologically and economically appropriate, a respectively suitable location of the respective charging pole must be chosen. Special planning tools exist today for the choice of location which can use and process data to determine the suitable location and in addition the power for a charging pole. Planning tools of this type are predominantly used primarily for scientific research purposes, as indicated, for example, in the publication by Y. Ahn and H. Yeo: “Using real taxi trajectory data generated density map of charging infrastructure”. Conversely, commercial providers have hitherto frequently located their charging poles at points that are strategically important to them, e.g., on busy routes, regardless of the appropriateness of the location.

### SUMMARY

The teachings of the present disclosure provide methods, computing devices, computer programs, and data carriers which can in each case design the utilization of a traffic infrastructure in such a way that the design can be used for planning a charging infrastructure. For example, some embodiments include a method for designing a traffic infrastructure on the basis of height data (12) of a height monitoring object, having the steps of:
a) evaluating the height data (12) which are detected by at least one sensor unit of the at least one height monitoring object, and generating an evaluation dataset on the basis of the height data (12);
b) identifying at least one component of the traffic infrastructure from the evaluation dataset;
c) identifying at least one user of the traffic infrastructure from the evaluation dataset; and
d) determining a utilization (14) of the at least one component by the at least one user of the traffic infrastructure.

In some embodiments, at least one location for at least one charging infrastructure component is determined on the basis of the determined utilization (14).

In some embodiments, at least one of the steps of the method is carried out by at least one learning algorithm and/or at least one neural network.

In some embodiments, a parking facility for at least one vehicle is identified as the component and/or a vehicle is identified as the user.

In some embodiments, ground data (26) of a ground sensor unit are evaluated and incorporated into the evaluation dataset.

In some embodiments, background data (28) are additionally incorporated into the evaluation dataset.

In some embodiments, the background data comprise at least one model of a distribution network and/or data of a geographic information system (GIS) and/or traffic data and/or at least one statistic relating to user behavior.

As another example, some embodiments include an electronic computing device which is designed to carry out a method as described herein.

As another example, some embodiments include a computer program which is loadable directly into a memory of an electronic computing device, having a program means in order to carry out the steps of the method as described herein when the program is executed in a computing device.

As another example, some embodiments include an electronically readable data carrier with electronically readable control information stored thereon which comprises at least one computer program that it carries out a method as described herein when the data carrier is used in an electronic computing device.

### BRIEF DESCRIPTION OF THE DRAWINGS

Further features, details, and advantages of the teachings herein are set out in the following description of an example embodiment and with reference to the drawing.

The single FIGURE shows a schematic diagram to illustrate a method for designing a traffic infrastructure on the basis of height data of a height monitoring object incorporating teachings of the present disclosure.

### DETAILED DESCRIPTION

Some embodiments include a method for designing a traffic infrastructure on the basis of height data of a height monitoring object. In a step a) of the method, the height data which are detected by at least one sensor unit of the at least one height monitoring object are evaluated. Furthermore, in the step a), an evaluation dataset is generated on the basis of the height data. The height data can contain, for example, electromagnetic information relating to the entire electromagnetic range or a subrange of the electromagnetic spectrum. This subrange of the electromagnetic spectrum can be located, for example, in a range visible to the human eye and/or in an infrared range and/or an ultraviolet range and/or a radio range, for example for radar images. The height data may contain information in wavelength ranges of the electromagnetic spectrum which are suitable for transporting or containing information or features of a traffic infrastructure.

In some embodiments, the height monitoring object is capable of positioning the sensor unit which may, for example, be a camera at a height above a ground or partial area of the earth's surface in such a way that the ground or the partial area can be observed or monitored by the sensor unit from above. The height monitoring object can therefore be a satellite, a balloon and/or an aircraft. Satellite images, for example, are thus recorded by a satellite in the aforementioned case in which the sensor unit is a camera. In the case of an aircraft or a balloon, the height data can be aerial photographs. Depending on the means by which or with which the method is carried out, for example by means an electronic computing device, the height data can be received by said computing device, for example via an interface so that the height data are thus available to be evaluated or for the evaluation.

Following or during the reception, the data can already be stored in a storage area or storage device of the computing device and can be retained in retrievable form. The evaluation can be understood to mean that the height data are processed depending on their characteristics in such a way that they can be retained for steps b) and/or c) of the method.

In step b) of the method, at least one component of the traffic infrastructure is identified from the evaluation dataset. The traffic infrastructure is, in particular, at least partially a road network which can comprise or have entrances and exits, junctions and parking lots or parking facilities and further components. At least one of the aforementioned components is identified or derived from the evaluation dataset on the basis of the height data or their evaluation.

In a further step c) of the method, at least one user of the traffic infrastructure is identified from the evaluation dataset. For the example of the road network, the user of the traffic infrastructure is therefore, for example, a vehicle which is identified by step c) of the method.

In a step d) of the method, a utilization of the at least one component by the at least one user of the traffic infrastructure is determined, in particular on the basis of the evaluation dataset. In some embodiments, step d) takes place following the identification of the at least one component and the identification of the at least one user (steps b) and c)), so that the utilization can be determined.

In some embodiments, a planning of a charging infrastructure, in particular for electrically drivable vehicles, is enabled on the basis of the utilization. In some embodiments, the method can be carried out economically compared with existing methods which manually, for example, determine a location for a charging infrastructure component. It is further possible on the basis of the method to perform calculations or to perform determinations, for example, on the basis of the utilization which can enable the general design of this traffic infrastructure, in particular of a distribution network. Information obtained by means of the method or the generated data could be used in further steps, for example, to perform a distribution network planning. Along with the direct benefit for designing the traffic infrastructure and therefore the charging infrastructure or the distribution network, it is further possible for further, in particular indirect and not yet measurable, usage scenarios to be created.

In some embodiments, at least one location for a charging infrastructure component, such as, for example, a charging pole for supplying at least one electrical energy storage device of an electrically drivable motor vehicle with electrical energy, is determined on the basis of the determined utilization, in particular in a further step e) of the method. In other words, it is possible to determine a particularly advantageous location for the charging infrastructure component depending on a utilization, since a particularly accurate estimation of the demand for the traffic infrastructure or the charging infrastructure component assigned to it is achievable. A placement or the correct location for charging poles for electrically drivable vehicles or electric vehicles is particularly important in the planning of traffic infrastructure or, in particular, the charging infrastructure.

One major challenge is, in particular, the correct determination of a parking location and a parking duration of these electric vehicles. This can be determined in each case by determining the utilization. In some embodiments, the determination of the utilization can thus be carried out in terms of the parking location and the parking duration. In some embodiments, traffic flow data can similarly be determined for the utilization which may, however, play only a subordinate role in determining the at least one location for at least one charging infrastructure component.

In some embodiments, inferences can be made concerning the parking duration or a length of stay of at least one electrically drivable vehicle in at least one specific location, in particular at the parking location. The methods described herein can thus provide a facility for the charging infrastructure to be appropriately expanded or supplemented during its planning, as a result of which the quality of the planning can be increased. Height data are evaluated for this purpose, permitting inferences to be made concerning a time dependence of the utilization. Inferences can thus be drawn concerning the selection of the location.

In some embodiments, at least one of the steps of the method, i.e. at least the evaluation and or the respective identification and/or the determination of the utilization and/or of the location is carried out by at least one learning algorithm and/or at least one neural network. Both the algorithm and the neural network are variations of a machine learning. Essentially two approaches can be adopted in the machine learning: firstly, symbolic approaches, such as propositional systems, in which the knowledge—both the examples and the induced rules—is explicitly represented, which can be expressed, for example, by the algorithm. Secondly, subsymbolic systems such as, in particular artificial, neural networks, which operate on the basis of the model of the human brain and in which the knowledge is implicitly represented.

Combinations of the at least one algorithm and the at least one neural network are also conceivable. The algorithm can have a learning capability, in particular a self-learning capability, and can be executed, for example, by the neural network, or the neural network receives instructions corresponding to the learning algorithm. This means that the method or at least one step of the method can be carried out in an automated manner, wherein a quasi-artificial intelligence can carry out at least one method step. The learning algorithm can be used to initiate the neural network.

If, for example, the height data are images, patterns can be recognized in said images, for example, by the neural network or the learning algorithm or the artificial intelligence, on the basis of which, for example, the component or the user can be identified. Thus, for example, particularly if the height data contain a temporal sequence, it can be determined, for example, how long a vehicle remains at a specific location, in particular a parking lot as a component of the traffic infrastructure, and it is additionally possible, for example, to evaluate characteristics of the surrounding area also, so that, for example, the location can be determined for the charging infrastructure component.

The neural network or the learning algorithm can be trained by means of training data, wherein the training or the learning takes place, in particular, through deep learning and/or reinforcement learning. The learning algorithm can be used, in particular, for image processing, as a result of which structures and patterns of, for example, cities and therefore the at least one component of the traffic infrastructure and vehicles can be recognized by means of an artificial intelligence. Generated image features, for example from different layers of the algorithm or of the neural network, can be categorized and can ultimately be assigned to predefined categories which can be regarded as a classification of the component.

The number of parking cars or vehicles, for example, can thus be localized by the method, in particular for at least one defined time. In some embodiments, significant findings of a mobility behavior, particularly in terms of the use of, in particular electrically drivable, vehicles of a population, for example of the city or of an area, can be obtained.

In some embodiments, the height data may be processed by means of machine learning or deep learning, artificial intelligence AI or, in particular, in heuristic, optimization methods. At least one vehicle, for example, can be identified from the height data, for example by the learning algorithm, and its parking duration can be determined, wherein a hybrid algorithm may be used. A hybrid algorithm offers the facility whereby, for example in the case of difficult questions in which the learning algorithm, for example, cannot achieve an identification, an, in particular human, evaluation can be used. This can happen, in particular, in a training phase of the algorithm or of the network, so that the recognition or identification can advantageously be learnt for the method, wherein the training data are preferably particularly comprehensive, i.e. contain as much data as possible which can be conclusive for the learning of the identification. The method can be carried out particularly efficiently and therefore, for example, in a particularly short time through the use of the learning algorithm and of the neural network.

In some embodiments, a parking facility for at least one vehicle or the vehicle is identified as the component, and/or a vehicle, in particular an electrically drivable vehicle, such as an electric vehicle which represents a motor vehicle, is identified as the user. It should also be noted here that vehicles can only be characterized with difficulty, particularly in terms of their drive type, from the height data which comprise, in particular, an aerial photograph or a satellite image, due to the angle of recording which is essentially perpendicular to the ground, wherein specific type characteristics would have to make the drive type uniquely determinable in a plan view of the vehicle also. However, this is not at all necessary for the planning or the determination of the utilization of the component of the traffic infrastructure, since it can be assumed that a conversion to electromobility will further continue, as a result of which the at least one location for the charging infrastructure component is learnable or determinable by the method on the basis of the determination of the utilization.

The proportion of electric vehicles relative to a totality of vehicles is thus increasing, as a result of which, for example, an estimation can be made on the basis of this proportion, so that inferences can be made concerning the electric vehicles parking in the area or region concerned due to the proportion of the total vehicle stock. In addition, a distinction can be made in the height data which comprise, in particular, aerial photographs and/or satellite images, for example between a passenger vehicle as a vehicle and, for example, a bus of a local public transport system as a vehicle. As a result, for example, in addition to the planning of the location of the charging infrastructure component, the type of the charging infrastructure is also determinable.

Thus, for example, it is advantageous to provide a greater charging current for a bus in order to be able to charge an energy store of the bus particularly efficiently, in particular particularly quickly. The parking facility is also substantially more significant as the component for the planning of the location of the charging infrastructure component than, for example, a road section on which the vehicles travel, since charging is not possible there at least by means of a charging pole. In some embodiments, if the charging infrastructure component comprises, for example, coils embedded in a road for inductive charging, a route section in which, for example, a vehicle travels at a particularly slow and/or constant speed could be used in determining the utilization of the traffic infrastructure. Ground data can be advantageous here in comparison with the height data in order to measure the speed.

In some embodiments, ground data of a ground sensor unit are also incorporated into the evaluation dataset and are evaluated. The utilization of the traffic infrastructure is thus determined depending on the ground data. The ground sensor unit comprises, for example, cameras, such as monitoring cameras, wherein corresponding cameras can be used depending on the type of the charging infrastructure, i.e., for example, a charging pole or an inductive charging coil. The monitoring camera of a traffic monitoring facility and/or, for example, the monitoring camera of a parking lot, for example of a retail outlet, but also of a public parking lot, can be used, for example, for a road section. The facility is thus provided whereby, via the determination of the utilization of the component of the traffic infrastructure, redundant data can be used, as a result of which the method can be carried out particularly efficiently. Due to the ground data, it can additionally be possible in a particularly advantageous manner to distinguish between drive types of vehicles. The number of electric vehicles as a proportion of the totality of vehicles or the entire vehicle stock could thus be determinable.

In some embodiments, background data are additionally incorporated into the evaluation dataset so that the utilization of the traffic infrastructure can thus be determined depending on the background data. In some embodiments, the background data comprise at least one model for a distribution network and/or data of a geographic information system (GIS) and/or traffic data and/or at least one statistic relating to a user behavior. In other words, background data containing information useful for a precise analysis of the traffic infrastructure and therefore for the identification and/or evaluation and/or determination can be used for a particularly advantageous determination of the utilization by means of the method. The background data can thus contain, for example, at least the model of the distribution network which overlaps, in particular geographically, in particular with the traffic infrastructure.

In some embodiments, the distribution network is a distribution network for electrical energy and therefore, for example, in particular an electricity grid. Through the incorporation of the information relating to an electricity grid into the evaluation data, the selection of a location for a charging infrastructure component can be made, since it can be made particularly efficiently depending on the distribution network or electricity grid, since, for example, an energy quantity deliverable by the distribution network is known. In some embodiments, GIS data can be used as background data and therefore in the evaluation dataset. The geographical information system provides a framework for the acquisition, management and analysis of data which has its origin in the geography in particular. This geographic information system analyses the spatial position and organizes information layers into, for example, visualizations by means of maps and, for example, 3D scenes.

By means of the data provided by the geographic information system, the facility is thus provided, for example, for recognizing patterns in the height data, as a result of which, for example, the location planning of the charging infrastructure component can be performed. In some embodiments, traffic data containing, in particular, a traffic volume, for example, can be used as the background data, thus generally enabling correlation of charging infrastructures in addition to, for example, the standing time of the vehicle at the parking facility with a general traffic volume. At least one statistic relating to user data can further be present in the background data, containing, for example, the length of stay of a person in a supermarket or the route between the place of residence and the place of work or the like which can similarly be taken into account in the location selection.

In some embodiments, for example, infrastructure data, if not actually derivable from the height data, can also be incorporated as background data, so that a distinction can be made, for example, between a residential area and a commercial area so that, for example, noise pollution possibly occurring due to the charging infrastructure as a result of the traffic can be taken into account. In some embodiments, further background data can be used which are suitable, in particular, for supplementing and/or supporting the determination of the location of the charging infrastructure component in such a way that the location is chosen so that the benefit for the user of the traffic infrastructure is particularly great.

In some embodiments, a computer program implements a method as described herein on an electronic computing device. The computer program can also be present here in the form of a computer program product which is loadable directly into a memory or memory area of the computing device, with program means to carry out a method as described herein if the computer program product is executed in, in particular, the computing device or by the computing device. In some embodiments, an electronically readable data carrier comprises electronically readable control information stored on it which comprises at least one computer program as described herein. The characteristics and developments of the methods indicated above and below and the corresponding advantages are in each case transferable accordingly to the further embodiments, and vice versa. A respective explicit elaboration of the advantages and advantageous designs for the electronic computing device, the computer program and the electronically readable data carrier is omitted here for this reason.

The single FIGURE shows a schematic diagram 10 which outlines sequences and functional relationships of a method for designing a traffic infrastructure on the basis of height data 12 of a height monitoring object. For the planning, in particular, of a charging infrastructure which is regarded in dependence on a traffic infrastructure or as a part thereof, in order to achieve the conversion to electromobility as advantageously as possible, the method comprises a plurality of steps:

In a first step a), the height data 12 which are detected by at least one sensor unit which has, for example, a camera sensor, of the at least one height monitoring object are evaluated. Furthermore, in this step, an evaluation dataset is generated on the basis of the height data 12, containing, in particular, the height data themselves, for example, and already prepares said height data, for example by means of image recognition, for a subsequent identification of at least one component of the traffic infrastructure or of a user of the traffic infrastructure, whereby, for example, corresponding areas of the image can be marked.

In step b), the at least one component of the traffic infrastructure is identified from or on the basis of the evaluation dataset.

In a further step c), the at least one user of the traffic infrastructure is identified from or on the basis of the evaluation dataset.

In a step d), a utilization 14 of the at least one component by the at least one user of the traffic infrastructure is determined.

The utilization 14 can thus be understood as output information of the method and can be interpreted, for example, as an estimation of the demand for traffic infrastructure.

In some embodiments, a location for a charging infrastructure component of the charging infrastructure or for or in the traffic infrastructure is determined, in particular in a location determination module 16, depending on the determined utilization 14, in particular by means of a learning algorithm and/or a neural network, wherein the learning algorithm can initialize the neural network.

The determination of the location can be performed as step e). Steps a) to d) of the method can, for example, similarly be carried out, in addition to step e), by a neural network or a learning algorithm, wherein this can take place in a determination module 20. The location is provided by the location determination module 16 as the output 18, wherein the energy quantity required at the location for the provision can be determined by the location determination module 16, for example in addition to the location itself, on the basis of the utilization 14 for the output 18.

Training data 22 which can be retrieved, in particular, in a learning phase, for example, in particular, by means of deep learning, can be provided for the respective neural network or the respective learning algorithm. In addition, for example, the utilization determination can be improved by a hybrid approach, advantageously by a human user also by means of reinforcement learning which can also similarly be performed independently by the respective learning algorithm or neural network depending on the training data 22.

So that the method can be used for the planning of a charging infrastructure, in particular, for example, in the form of inductive charging pads and/or charging poles for electrically drivable electric vehicles, a parking facility for at least one vehicle, in particular a parking lot, is identified as the component, and/or a vehicle, in particular a passenger vehicle and/or a vehicle for local public transport, is identified as the user of the infrastructure. In addition, external data 24 can be used for the method, wherein the external data 24 can be ground data 26 of a ground sensor unit, such as, for example, a monitoring camera, which are evaluated and incorporated in the evaluation dataset.

In some embodiments, the external data 24 can comprise background data 28 which can also similarly be incorporated into the evaluation dataset, wherein the utilization 14 of the traffic infrastructure is thereby determined depending on the background data 28. In some embodiments, through the incorporation of the ground data 26 into the external data 24, the former are incorporated into the evaluation data and the utilization 14 is thereby determined depending on the background data.

In some embodiments, the background data 28 can contain at least one model of a distribution network, in particular an electricity grid, which overlaps with the traffic infrastructure analyzed by the method. In some embodiments, they can contain information of a geographical information system (GIS), which particularly advantageously contains information, for example, relating to geographic characteristics or similar. In some embodiments, the traffic data can form part of the background data 28, describing, for example, a traffic volume. In some embodiments, at least one statistic relating to a user behavior, for example the time spent by a person in a supermarket, can be determined for the background data 28. It is thus possible by means of the statistic, for example, if the utilization 14 can be determined as precisely as possible in the height data 12 or for the utilization 14 by means of the height data 12 in combination with the background data 28, if, in a temporal sequence of the height data 12, for example, a recording for the height data 12 can only be made every quarter of an hour and the length of time spent by a customer in a supermarket is only ten minutes.

The height reconnaissance object may be a satellite, so that the height data 12 are satellite images. In some embodiments, the height reconnaissance object can be an aircraft and/or a balloon or a comparable flying object on which the sensor unit for recording the height data 12 is in each case mounted, wherein the height data 12, if they are recorded by an aircraft or a balloon, are aerial photographs.

By means of the methods described herein, a planning for a development of the traffic infrastructure, for example, is possible, since at least one location for at least one charging infrastructure component, in particular for electrically driven vehicles, can be determined, since, for example, a parking location and a parking duration of the vehicle can be determined for the utilization 14, so that a location determined for the charging infrastructure component can be chosen as efficiently as possible.

The methods described herein can also be present in the form of a computer program or a computer program product which implements the method within a computing device. An electronically readable data carrier can also be present, having electronically readable control information stored thereon which comprises at least one described computer program product and is designed in such a way that it carries out a described method when the data carrier is used in, in particular, an electronic computing device.

### REFERENCE NUMBER LIST

10 Diagram
12 Height data
14 Utilization
16 Location determination module
18 Output
20 Determination module
22 Training data
24 External data
26 Ground data
28 Background data

What is claimed is:

1. A method for designing a traffic infrastructure on the basis of height data provided by a height monitoring object, the method comprising:
a) evaluating the height data detected by a sensor unit of the at height monitoring object and generating an evaluation dataset on the basis of the height data;
b) identifying a component of the traffic infrastructure from the evaluation dataset;
c) identifying a user of the traffic infrastructure from the evaluation dataset; and
d) determining a utilization of the component by the user.

2. The method as claimed in claim 1, further comprising determining a location for a charging infrastructure component on the basis of the determined utilization.

3. The method as claimed in claim 1, wherein at least one of the steps is carried out by a learning algorithm and/or a neural network.

4. The method as claimed in claim 1, wherein the component comprises a parking facility for a vehicle and/or the user comprises a vehicle.

5. The method as claimed in claim 1, further comprising incorporating ground data from a ground sensor unit into the evaluation dataset.

6. The method as claimed in claim 1, further comprising incorporating background data into the evaluation dataset.

7. The method as claimed in claim 6, wherein the background data comprise at least one of: a model of a distribution network, data of a geographic information system, traffic data, and/or a statistic relating to user behavior.

8. A system comprising:
a processor; and
a memory storing a set of instructions, the set of instructions, when accessed and executed by the processor, causing the processor to design a traffic infrastructure on the basis of height data provided by a height monitoring object, by:
a) evaluating the height data detected by a sensor unit of the height monitoring object and generating an evaluation dataset on the basis of the height data;
b) identifying a component of the traffic infrastructure from the evaluation dataset;
c) identifying a user of the traffic infrastructure from the evaluation dataset; and
d) determining a utilization of the component by the user.

9. (canceled)

10. A non-transitory electronically readable data carrier with electronically readable control information stored thereon, the information, when accessed and executed by a processor caousing the processor to design a traffic infrastructure on the basis of height data provided by a height monitoring object, by:
a) evaluating the height data detected by a sensor unit of the height monitoring object and generating an evaluation dataset on the basis of the height data;
b) identifying a component of the traffic infrastructure from the evaluation dataset;
c) identifying a user of the traffic infrastructure from the evaluation dataset; and
d) determining a utilization of the component by the user.
